(19) United States
(12) Patent Application Publication
(10) Pub. No.: US 2019/0129429 A1
(43) Pub. Date: May 2, 2019

(54) Systems and Methods for Determining Tractor-Trailer Angles and Distances

(71) Applicant: Uber Technologies, Inc., San Francisco, CA (US)

(72) Inventors: Soren Juelsgaard, El Sobrante, CA (US); Mike Carter, La Jolla, CA (US)

(21) Appl. No.: 15/992,346

(22) Filed: May 30, 2018

Related U.S. Application Data
(60) Provisional application No. 62/577,426, filed on Oct. 26, 2017.

(51) Int. Cl. G05D 1/02

(52) U.S. Cl. CPC G05D 1/021; B60Y 2200/148; G05D 1/0231; G05D 1/0257

(57) ABSTRACT

Systems and methods are directed to determining one or more angles and/or distances between at least first and second portions of a partially or fully autonomous vehicle. In one example, a system includes one or more processors and memory including instructions that, when executed by the one or more processors, cause the one or more processors to perform operations. The operations include obtaining sensor data. The operations further include determining at least one angle between a first portion and a second portion of an autonomous vehicle based at least in part on the sensor data. The operations further include determining at least one distance between the first portion and the second portion of the autonomous vehicle based at least in part on the sensor data. The operations further include providing the at least one angle and at least one distance for use in controlling operation of the autonomous vehicle.

The present application is based on and claims the benefit of U.S. Provisional Application No. 62/577,426, having a filing date of Oct. 26, 2017, which is incorporated by reference herein.

### FIELD

The present disclosure relates generally to operation of an autonomous vehicle.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether.

### SUMMARY

Aspects and advantages of embodiments of the present disclosure will be set forth in part in the following description, or can be learned from the description, or can be learned through practice of the embodiments.

One example aspect of the present disclosure is directed to a system for detecting angles and/or distances between a first portion and a second portion of an autonomous vehicle. The system includes one or more processors and memory including instructions that, when executed by the one or more processors, cause the one or more processors to perform operations. The operations include obtaining sensor data. The operations further include determining at least one angle between a first portion and a second portion of an autonomous vehicle based at least in part on the sensor data. The operations further include determining at least one distance between the first portion and the second portion of the autonomous vehicle based at least in part on the sensor data. The operations further include providing the at least one angle and at least one distance for use in controlling operation of the autonomous vehicle.

Another example aspect of the present disclosure is directed to a computer-implemented method for detecting tractor-trailer positioning. The method includes obtaining, by a computing system comprising one or more computing devices, sensor data from one or more sensors, wherein the one or more sensors are positioned on one or more of a tractor or a trailer of an autonomous truck and configured to provide a field of view that includes the other one of the tractor and the trailer of the autonomous truck. The method further includes determining, by the computing system, one or more angles between the tractor and the trailer of the autonomous truck based at least in part on the sensor data. The method further includes determining, by the computing system, one or more distances between the tractor and the trailer of the autonomous truck based at least in part on the sensor data. The method further includes providing, by the computing system, the one or more angles and one or more distances for use in controlling operation of the autonomous truck.

Another example aspect of the present disclosure is directed to an autonomous vehicle. The autonomous vehicle includes a vehicle computing system and one or more sensors positioned onboard the autonomous vehicle and configured to provide a field of view that includes the autonomous vehicle's surrounding environment as well as one or more portions of the autonomous vehicle. The vehicle computing system includes one or more processors and memory including instructions that, when executed by the one or more processors, cause the one or more processors to perform operations. The operations include obtaining sensor data from the one or more sensors. The operations further include detecting one or more objects that are proximate to the autonomous vehicle based at least in part on the sensor data. The operations further include determining one or more angles between a first portion and a second portion of the autonomous vehicle based at least in part on the sensor data. The operations further include determining one or more distances between the first portion and the second portion of the autonomous vehicle based at least in part on the sensor data. The operations further include providing the one or more angles and one or more distances for use in controlling operation of the autonomous vehicle.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of a vehicle according to example embodiments of the present disclosure;

FIG. 2 depicts a flowchart diagram of example operations for determining angle and/or distance data associated with an autonomous truck according to example embodiments of the present disclosure;

FIG. 3 depicts a flowchart diagram of example operations for determining angle and/or distance data associated with an autonomous truck according to example embodiments of the present disclosure;

FIGS. 4A-D depict block diagrams of example sensor placements according to example embodiments of the present disclosure;

FIG. 5 depicts a block diagram of an example sensor coverage configuration according to example embodiments of the present disclosure;

FIGS. 6A and 6B depict example configurations of first and second portions of an autonomous vehicle with sensor positioning and fields of view according to example embodiments of the present disclosure;

FIGS. 7A and 7B depict example configurations for determining distance(s) and angle(s) between first and second portions of an autonomous vehicle according to example embodiments of the present disclosure; and

FIG. 8 depicts a block diagram of an example computing system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to determining one or more angles and/or distances between at least first and second portions of a partially or fully autonomous vehicle, such as a tractor and a trailer of an autonomous truck. In addition, aspects of the present disclosure provide for determining operations of the partially or fully autonomous vehicle based on the determined angles and/or distances. In particular, the systems and methods of the present disclosure can include sensors, such as one or more cameras, lidar sensors, and/or radar sensors for example, positioned onboard a partially or fully autonomous vehicle, such as an autonomous truck. The one or more sensors can be positioned at one or more respective locations relative to the partially or fully autonomous vehicle such that a field of view of the one or more sensors includes at least some part of the first portion and/or the second portion of the vehicle. Such configuration can assist in providing data regarding the position and/or movement of one or more portions of the vehicle.

In particular, according to example aspects of the present disclosure, an autonomous vehicle can drive, navigate, operate, etc. with minimal and/or no interaction from a human driver to provide a vehicle service. By way of example, an autonomous vehicle can be an autonomous truck that is configured to autonomously navigate to deliver a shipment to a destination location. In order to autonomously navigate, the autonomous truck can include a plurality of sensors (e.g., lidar system(s), camera(s), radar system(s), etc.) configured to obtain sensor data associated with the autonomous vehicle's surrounding environment as well as the position and/or movement of multiple portions of the autonomous vehicle, such as, for example, a tractor portion and a trailer portion of an autonomous truck. For example, in some implementations, one or more sensors (e.g., cameras, lidar sensors, and/or radar sensors, etc.) can be positioned on an autonomous truck, for example, on the tractor portion (e.g., the front, top, and/or back of the tractor, etc.) and/or on the trailer portion (e.g., the front, rear, and/or Mansfield bar of the trailer, etc.) and can be configured to capture sensor data (e.g., image data, lidar sweep data, radar data, etc.) to provide for determining one or more angles and/or one or more distances between the tractor portion and the trailer portion of the autonomous truck.

More particularly, an autonomous vehicle (e.g., a ground-based vehicle, air-based vehicle, other vehicle type, etc.) can include a variety of systems onboard the autonomous vehicle to control the operation of the vehicle. For instance, the autonomous vehicle can include one or more data acquisition systems (e.g., sensors, image capture devices, etc.), one or more vehicle computing systems (e.g., for providing autonomous operation), one or more vehicle control systems, (e.g., for controlling acceleration, braking, steering, etc.), and/or the like. The data acquisition system(s) can acquire sensor data (e.g., lidar data, radar data, image data, etc.) associated with one or more objects (e.g., pedestrians, vehicles, etc.) that are proximate to the autonomous vehicle and/or sensor data associated with the vehicle path (e.g., path shape, boundaries, markings, etc.). The sensor data can include information that describes the location (e.g., in three-dimensional space relative to the autonomous vehicle) of points that correspond to objects within the surrounding environment of the autonomous vehicle (e.g., at one or more times). The data acquisition system(s) can further be configured to acquire sensor data associated with the position and movement of the autonomous vehicle, for example, sensor data associated with the position and movement of a tractor and/or a trailer of an autonomous truck. The data acquisition system(s) can provide such sensor data to the vehicle computing system.

In addition to the sensor data, the vehicle computing system can obtain map data that provides other detailed information about the surrounding environment of the autonomous vehicle. For example, the map data can provide information regarding: the identity and location of various roadways, road segments, buildings, or other items; the location and direction of traffic lanes (e.g. the boundaries, location, direction, etc. of a travel lane, parking lane, a turning lane, a bicycle lane, and/or other lanes within a particular travel way); traffic control data (e.g., the location and instructions of signage, traffic signals, and/or other traffic control devices); and/or any other map data that provides information that can assist the autonomous vehicle in comprehending and perceiving its surrounding environment and its relationship thereto.

The vehicle computing system can include one or more computing devices and include various subsystems that can cooperate to perceive the surrounding environment of the autonomous vehicle and determine a motion plan for controlling the motion of the autonomous vehicle. For instance, the vehicle computing system can include a perception system, a predication system, and a motion planning system. The vehicle computing system can receive and process the sensor data to generate an appropriate motion plan through the vehicle's surrounding environment.

The perception system can detect one or more objects that are proximate to the autonomous vehicle based on the sensor data. In particular, in some implementations, the perception system can determine, for each object, state data that describes a current state of such object. As examples, the state data for each object can describe an estimate of the object's: current location (also referred to as position); current speed/velocity; current acceleration; current heading; current orientation; size/footprint; class (e.g., vehicle class versus pedestrian class versus bicycle class, etc.); and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time, and thereby produce a presentation of the world around an autonomous vehicle along with its state (e.g., a presentation of the objects within a scene at the current time along with the states of the objects).

The prediction system can receive the state data from the perception system and predict one or more future locations for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system can determine a motion plan for the autonomous vehicle based at least in part on predicted one or more future locations for the object provided by the prediction system and/or the state data for the object provided by the perception system. Stated differently, given information about the classification and current locations of objects and/or predicted future locations of proximate objects, the motion planning system can determine a motion plan for the autonomous vehicle that best navigates the autonomous vehicle along the determined travel route relative to the objects at such locations.

As one example, in some implementations, the motion planning system can determine a cost function for each of one or more candidate motion plans for the autonomous vehicle based at least in part on the current locations and/or predicted future locations of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the classifications, current locations, and/or predicted future locations of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control acceleration, steering, braking, etc.) to execute the selected motion plan.

More particularly, in some implementations, to provide for improved operation of an autonomous vehicle (e.g., an autonomous truck), the vehicle computing system can use sensor data captured by one or more sensors onboard the autonomous vehicle (e.g., cameras, lidar sensors, radar sensors, etc.) to determine one or more angles and/or one or more distances between a first portion and a second portion of the autonomous vehicle (e.g., the tractor and the trailer of an autonomous truck) and provide for determining one or more operations of the autonomous vehicle based in part on the one or more angles and/or one or more distances (e.g., modifying a motion plan, etc.).

According to example aspects of the present disclosure, one or more sensors, such as cameras, lidar sensors, radar sensors, and/or the like, can be positioned on a first portion of an autonomous vehicle (e.g., tractor) and/or a second portion of an autonomous vehicle (e.g., trailer), for example, based on field of view requirements. In some implementations, for example, one or more sensors can be positioned on the autonomous vehicle to provide for capturing sensor data to allow for determining the position of the trailer and how it is moving, for example, in relation to the tractor, and to provide for analyzing dynamic responses of the autonomous vehicle.

In some implementations, one or more sensors can be positioned on or near the rear of the autonomous truck (e.g., the rear of the trailer) and configured to provide fields of view of the tractor and trailer to allow for capturing sensor data to provide for determining the position of the trailer and how it is moving (e.g., determining angles and/or distances between the tractor and trailer). For example, in some implementations, one or more sensors can be positioned on an under-ride bar (e.g., Mansfield bar) at the rear of the trailer and can be configured to provide data regarding features in the surrounding environment (e.g. lane markers, roadway geometry, geographic features, etc.) for use in determining one or more angles and/or distances between the tractor and trailer. In some implementations, one or more sensors of an existing autonomy system can provide sensor data in a field of view of the tractor and/or trailer to allow for determining one or more angles and/or distances between the tractor and trailer. In some implementations, one or more sensors can be positioned on or near the front of the autonomous truck (e.g., the tractor) at positions that provide good vantage points of the trailer and can provide sensor data to allow for determining one or more angles and/or distances between the tractor and trailer.

The one or more sensors can be configured for detecting edges of the trailer and/or tractor, one or more specific targets located on the trailer and/or tractor, one or more surfaces of the trailer and/or tractor, and/or like methods for providing and/or analyzing frames of reference, and enable determining one or more angles and/or distances between the tractor and trailer, based at least in part on the detected edges, surfaces, targets, and/or the like. In some implementations, the angles and/or distances between a tractor and trailer can be determined by evaluating one or more detected edges, surfaces, targets, and/or the like of the trailer relative to one or more detected edges, surface, targets, and/or the like of the tractor (e.g., when edges, surfaces, and/or targets of the tractor are also within the field of view of the one or more sensors), or vice versa. In some implementations, the angles and/or distances between a tractor and trailer can be determined by evaluating one or more detected edges, surfaces, targets, and/or the like of the trailer and/or tractor relative to a known location and/or orientation of the one or more sensors.

Additionally or alternatively, in some implementations, a transform between a reference frame of the tractor and a reference frame of the trailer can be determined for use in determining the one or more angles and/or distances. For example, knowing a reference frame of the tractor (e.g., tractor reference frame related to sensors, etc.) and a reference frame of the trailer (e.g., trailer reference frame related to sensors, etc.), a transform between the two reference frames can be determined such that sensor data from the different reference frames between the tractor and trailer can be compared and used in determining one or more angles and/or distances between the tractor and the trailer. In some implementations, a transform between a tractor and a trailer can be determined by concurrently localizing both the tractor and the trailer independently to features in the surrounding environment of the autonomous vehicle (e.g., lane markers, roadway geometry, geographic features, etc.). A transform between the tractor and the trailer can then be determined based on their independent transforms to a common frame of reference.

More particularly, in some implementations, the one or more sensors can be positioned at a location (e.g., on or relative to an exterior surface) of a given portion of an autonomous vehicle (e.g., first portion) and oriented such that a field of view of the one or more sensors includes a different portion of an autonomous vehicle (e.g., second portion). In some embodiments, the field of view can include the different portion of the autonomous vehicle as well as the given portion of the autonomous vehicle on which the sensor(s) are positioned.

For example, the one or more sensors can be positioned on a first portion of an autonomous truck (e.g., a tractor) and/or on a second portion of an autonomous truck (e.g., a trailer) that is different than and physically distinct from the first portion. In some implementations, a sensor that is positioned on a first portion of the autonomous vehicle can be positioned such that at least some part of a second portion of the autonomous vehicle is within a field of view of the sensor. In some implementations, a sensor positioned on a first portion of the autonomous vehicle can be positioned such that at least part of the first portion of the autonomous vehicle (e.g., the part of the first portion of the autonomous vehicle nearest to the second portion) is also within the field of the view of the sensor. Conversely, a sensor that is positioned on a second portion of the autonomous vehicle can be positioned such that at least some part of a first portion of the autonomous vehicle is within a field of view of the sensor. In some implementations, a sensor that is positioned on the second portion of the autonomous vehicle can be positioned such that at least part of the second portion of the autonomous vehicle (e.g., the part of the second portion of the autonomous vehicle nearest to the first portion) is also within the field of view of the sensor.

In some implementations, determining the position and movement of the autonomous vehicle can provide for analysis of complex vehicle dynamics, for example, by generating a matrix of multiple angles and three-dimensional positions of portions of an autonomous vehicle, generating state vectors of angles and three-dimensional positions for an autonomous vehicle, generating derivatives, and/or the like.

In some implementations, systems and methods of the present disclosure can include, employ, and/or otherwise leverage one or more models, such as machine-learned models, state estimation methods (e.g. extended Kalman filter (EKF), unscented Kalman filter (UKF), etc.), and/or the like, to provide data regarding the position and movement of portions of an autonomous vehicle, such as a trailer and/or tractor of an autonomous truck, including one or more angles and/or distances between portions of an autonomous vehicle. For example, a machine-learned model can be or can otherwise include one or more various model(s) such as, for example, neural networks (e.g., deep neural networks), or other multi-layer non-linear models. Neural networks can include recurrent neural networks (e.g., long, short-term memory recurrent neural networks), feed-forward neural networks, convolutional neural networks, and/or other forms of neural networks. For instance, supervised training techniques can be performed to train a model, for example, using labeled training data (e.g., ground truth data) to provide for detecting and identifying the position and movement of the autonomous vehicle by receiving, as input, sensor data associated with the portions of an autonomous vehicle, and generating, as output, estimates for one or more angles and one or more distances between the portions of the autonomous vehicle (e.g., between a tractor and a trailer). For example, in some implementations, labeled training data can be generated using high-fidelity alternate positional sensing (e.g., high-accuracy GPS data and/or inertial measurement unit (IMU) data, etc. from one or more sensors on the tractor and one or more sensors on the trailer).

In some implementations, the one or more machine-learned models can be trained using labeled training data reflecting various operating conditions for the autonomous vehicle such as, for example, day-time conditions, night-time conditions, different weather conditions, traffic conditions, and/or the like.

According to another aspect of the present disclosure, in some implementations, a vehicle computing system may capture and/or analyze sensor data at different rates based in part on the operating conditions. For example, in some implementations, sensor data may be captured at a first sensor rate for standard autonomy tasks and sensor data may be captured at a second rate (e.g., a higher rate) for determining position and movement of a trailer and tractor to allow for capturing the dynamics of the trailer and tractor. Additionally or alternatively, in some implementations, a single sensor capture rate may be provided, however, a faster processing cycle rate may be used for determining position and movement of a trailer and tractor. For example, in some implementations, sensor data may be captured at a high rate but the vehicle computing system may process the data at a lower rate for standard autonomy tasks (e.g., the sensor can capture data at a higher rate than the processing rate of the sensor data). In such situations, the vehicle computing system may process the sensor data at a higher rate in determining position and movement of a trailer and tractor.

In some implementations, the sensors can include lidar sensors specifically built and/or configured to allow for determining the position and movement of the trailer (e.g., the tractor-trailer angles and distances). For example, in some implementations, the lidar sensors can be configured to limit the time window for lidar returns to optimize for the range of distances possible between the tractor and the trailer. Additionally, the processing of the lidar data can be configured to minimize secondary effects based on the knowledge of the possible distance and position of the tractor and trailer.

According to another aspect of the present disclosure, in some implementations, one or more sensors can be positioned on or near the rear of the autonomous vehicle to additionally provide an improved field of view behind the autonomous vehicle and reduce blind spots.

The systems and methods described herein provide a number of technical effects and benefits. For instance, the vehicle computing system can locally (e.g., on board the autonomous vehicle) detect and identify the position and movement of the portions of the autonomous vehicle (e.g., the trailer and the tractor) and provide for earlier response to changes in the movement of the autonomous vehicle accordingly, thereby achieving improved operation and driving safety of the autonomous vehicle. For example, by determining the position and movement of the trailer and tractor, the systems and methods of the present disclosure can provide for more accurate and timely motion planning to respond to changes in vehicle dynamics. Additionally, by performing such operations onboard the autonomous vehicle, the vehicle computing system can avoid latency issues that arise from communicating with a remote computing system.

The systems and methods described herein may also provide a technical effect and benefit of enabling more comprehensive perception coverage of the space around an autonomous vehicle. In some implementations, data from one or more sensors configured on the trailer portion of an autonomous vehicle can be coherently combined with data from one or more sensors on the tractor, for example, to reduce blind spots and/or the like.

The systems and methods described herein can also provide resulting improvements to vehicle computing technology tasked with operation of an autonomous vehicle. For example, aspects of the present disclosure can enable a vehicle computing system to more efficiently and accurately control an autonomous vehicle's motion by achieving improvements in detection of position and movement of portions of the autonomous vehicle and improvements in vehicle response time to changes in vehicle dynamics.

With reference to the figures, example embodiments of the present disclosure will be discussed in further detail.

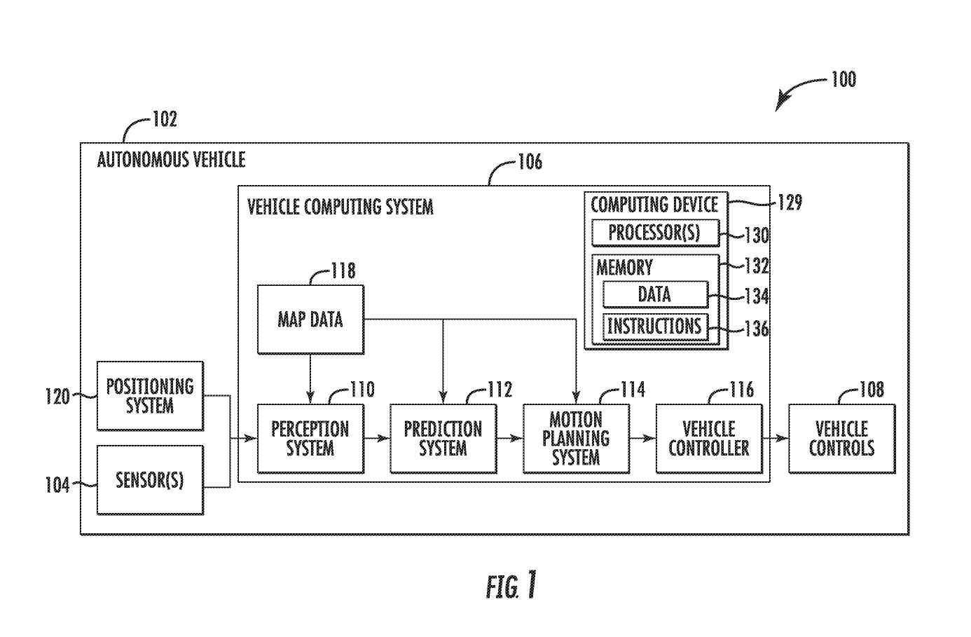

FIG. 1 depicts a block diagram of an example system 100 for controlling the navigation of an autonomous vehicle 102 according to example embodiments of the present disclosure. The autonomous vehicle 102 is capable of sensing its environment and navigating with little to no human input. The autonomous vehicle 102 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 102 can be configured to operate in one or more modes, for example, a fully autonomous operational mode and/or a semi-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 102 can include one or more sensors 104, a vehicle computing system 106, and one or more vehicle controls 108. The vehicle computing system 106 can assist in controlling the autonomous vehicle 102. In particular, the vehicle computing system 106 can receive sensor data from the one or more sensors 104, attempt to comprehend the surrounding environment by performing various processing techniques on data collected by the sensors 104, and generate an appropriate motion path through such surrounding environment. The vehicle computing system 106 can control the one or more vehicle controls 108 to operate the autonomous vehicle 102 according to the motion path.

The vehicle computing system 106 can include one or more processors 130 and at least one memory 132. The one or more processors 130 can be any suitable processing device (e.g., a processor core, a microprocessor, an ASIC, a FPGA, a controller, a microcontroller, etc.) and can be one processor or a plurality of processors that are operatively connected. The memory 132 can include one or more non-transitory computer-readable storage mediums, such as RAM, ROM, EEPROM, EPROM, flash memory devices, magnetic disks, etc., and combinations thereof. The memory 132 can store data 134 and instructions 136 which are executed by the processor 130 to cause vehicle computing system 106 to perform operations. In some implementations, the one or more processors 130 and at least one memory 132 may be comprised in one or more computing devices, such as computing device(s) 129, within the vehicle computing system 106.

In some implementations, vehicle computing system 106 can further include a positioning system 120. The positioning system 120 can determine a current position of the autonomous vehicle 102. The positioning system 120 can be any device or circuitry for analyzing the position of the autonomous vehicle 102. For example, the positioning system 120 can determine position by using one or more of inertial sensors, a satellite positioning system, based on IP address, by using triangulation and/or proximity to network access points or other network components (e.g., cellular towers, WiFi access points, etc.) and/or other suitable techniques for determining position. The position of the autonomous vehicle 102 can be used by various systems of the vehicle computing system 106.

As illustrated in FIG. 1, in some embodiments, the vehicle computing system 106 can include a perception system 110, a prediction system 112, and a motion planning system 114 that cooperate to perceive the surrounding environment of the autonomous vehicle 102 and determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a Light Detection and Ranging (LIDAR) system, a Radio Detection and Ranging (RADAR) system, one or more cameras (e.g., visible spectrum cameras, infrared cameras, etc.), and/or other sensors. The sensor data can include information that describes the location of objects within the surrounding environment of the autonomous vehicle 102.

As one example, for LIDAR system, the sensor data can include the location (e.g., in three-dimensional space relative to the LIDAR system) of a number of points that correspond to objects that have reflected a ranging laser. For example, LIDAR system can measure distances by measuring the Time of Flight (TOF) that it takes a short laser pulse to travel from the sensor to an object and back, calculating the distance from the known speed of light.

As another example, for RADAR system, the sensor data can include the location (e.g., in three-dimensional space relative to RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed. Thus, RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well. Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

In addition to the sensor data, the perception system 110 can retrieve or otherwise obtain map data 118 that provides detailed information about the surrounding environment of the autonomous vehicle 102. The map data 118 can provide information regarding: the identity and location of different travelways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travelway); traffic control data (e.g., the location and instructions of signage, traffic lights, or other traffic control devices); and/or any other map data that provides information that assists the vehicle computing system 106 in comprehending and perceiving its surrounding environment and its relationship thereto.

The perception system 110 can identify one or more objects that are proximate to the autonomous vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed; current heading (also referred to together as velocity); current acceleration; current orientation; size/footprint (e.g., as represented by a bounding shape such as a bounding polygon or polyhedron); class (e.g., vehicle versus pedestrian versus bicycle versus other); yaw rate; and/or other state information.

In some implementations, the perception system 110 can determine state data for each object over a number of iterations. In particular, the perception system 110 can update the state data for each object at each iteration. Thus, the perception system 110 can detect and track objects (e.g., vehicles, pedestrians, bicycles, and the like) that are proximate to the autonomous vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 114 can determine a motion plan for the autonomous vehicle 102 based at least in part on the predicted one or more future locations for the object provided by the prediction system 112 and/or the state data for the object provided by the perception system 110. Stated differently, given information about the current locations of objects and/or predicted future locations of proximate objects, the motion planning system 114 can determine a motion plan for the autonomous vehicle 102 that best navigates the autonomous vehicle 102 relative to the objects at such locations.

As one example, in some implementations, the motion planning system 114 can determine a cost function for each of one or more candidate motion plans for the autonomous vehicle 102 based at least in part on the current locations and/or predicted future locations of the objects. For example, the cost function can describe a cost (e.g., over time) of adhering to a particular candidate motion plan. For example, the cost described by a cost function can increase when the autonomous vehicle 102 approaches a possible impact with another object and/or deviates from a preferred pathway (e.g., a preapproved pathway).

Thus, given information about the current locations and/or predicted future locations of objects, the motion planning system 114 can determine a cost of adhering to a particular candidate pathway. The motion planning system 114 can select or determine a motion plan for the autonomous vehicle 102 based at least in part on the cost function(s). For example, the candidate motion plan that minimizes the cost function can be selected or otherwise determined. The motion planning system 114 can provide the selected motion plan to a vehicle controller 116. The vehicle controller 116 can generate one or more commands, based at least in part on the motion plan, which can be provided to one or more vehicle interfaces. The one or more commands from the vehicle controller 116 can provide for operating one or more vehicle controls 108 (e.g., actuators or other devices that control acceleration, throttle, steering, braking, etc.) to execute the selected motion plan.

Each of the perception system 110, the prediction system 112, the motion planning system 114, and the vehicle controller 116 can include computer logic utilized to provide desired functionality. In some implementations, each of the perception system 110, the prediction system 112, the motion planning system 114, and the vehicle controller 116 can be implemented in hardware, firmware, and/or software controlling a general purpose processor. For example, in some implementations, each of the perception system 110, the prediction system 112, the motion planning system 114, and the vehicle controller 116 includes program files stored on a storage device, loaded into a memory, and executed by one or more processors. In other implementations, each of the perception system 110, the prediction system 112, the motion planning system 114, and the vehicle controller 116 includes one or more sets of computer-executable instructions that are stored in a tangible computer-readable storage medium such as RAM hard disk or optical or magnetic media.

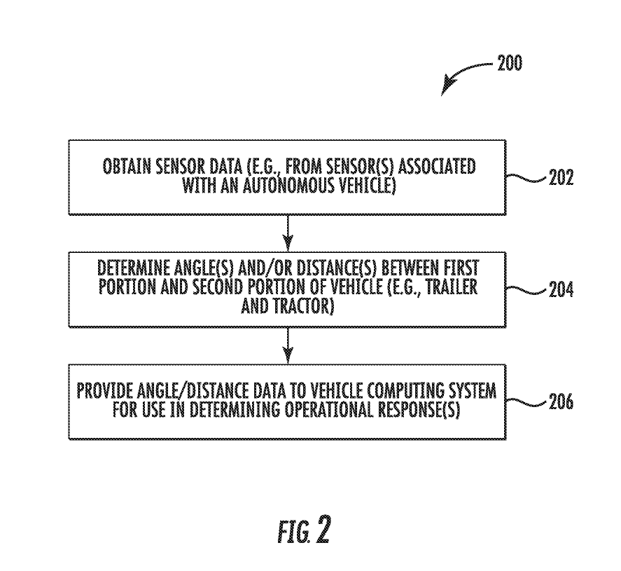

FIG. 2 depicts a flowchart diagram of example operations 200 for determining angle and/or distance data associated with an autonomous vehicle, such as an autonomous truck, according to example embodiments of the present disclosure. One or more portion(s) of the operations 200 can be implemented by one or more computing devices such as, for example, the vehicle computing system 106 of FIG. 1, the computing system 802 or 830 of FIG. 8, and/or the like. Moreover, one or more portion(s) of the operations 200 can be implemented as an algorithm on the hardware components of the device(s) described herein (e.g., as in FIGS. 1 and 8) to, for example, provide for determining one or more angles and/or one or more distances between portions of an autonomous vehicle.

At 202, one or more computing devices included within a computing system (e.g., computing system 106, 802, 830, and/or the like) can obtain sensor data from sensor(s) positioned on an autonomous vehicle. For example, sensors, such as one or more cameras, lidar sensors, and/or radar sensors for example, can be positioned onboard a partially or fully autonomous vehicle and can be positioned at one or more respective locations relative to the partially or fully autonomous vehicle such that a field of view of the one or more sensors includes at least some part of a first portion (e.g., a tractor portion) and/or a second portion of the vehicle (e.g., a trailer portion). The one or more sensors can be positioned on the autonomous vehicle to provide for capturing sensor data to allow for determining data regarding the vehicle (e.g., the tractor and/or the trailer).

At 204, the computing system can determine angle(s) and/or distance(s) between a first portion of the autonomous vehicle and a second portion of the autonomous vehicle (e.g., an autonomous truck having a tractor portion and a trailer portion) based at least in part on the sensor data. For example, in some implementations, the sensor data can be used in determining the position of the trailer and how it is moving, for example, in relation to the tractor, by determining one or more angles and/or distances between the tractor and trailer and provide for analyzing dynamic responses of the autonomous vehicle. In some implementations, the sensor data can provide for detecting edges of the trailer and/or tractor, surfaces of the trailer and/or tractor, specific targets located on the trailer and/or tractor, and/or the like to enable determining one or more angles and/or distances between the tractor and trailer. In some implementations, the angles and/or distances between a tractor and trailer can be determined by evaluating one or more detected edges, surfaces, and/or targets of the trailer relative to one or more detected edges, surfaces, and/or targets of the tractor (e.g., when edges, surfaces, and/or targets of the tractor are also within the field of view of the one or more sensors), or vice versa. In some implementations, the angles and/or distances between a tractor and trailer can be determined by evaluating one or more detected edges, surfaces, and/or targets of the trailer relative to a known location and/or orientation of the one or more sensors.

At 206, the computing system can provide the angle data and/or distance data, for example, to a vehicle computing system, for use in determining one or more operations for the autonomous vehicle. In some implementations, the vehicle computing system can use the angle data and/or distance data in determining the positioning and/or movement of the first portion and the second portion of the autonomous vehicle relative to each other. The vehicle computing system can determine an appropriate vehicle response, for example, in a motion planning system and/or the like, based at least in part on the positioning of the first portion and the second portion of the autonomous vehicle relative to each other.

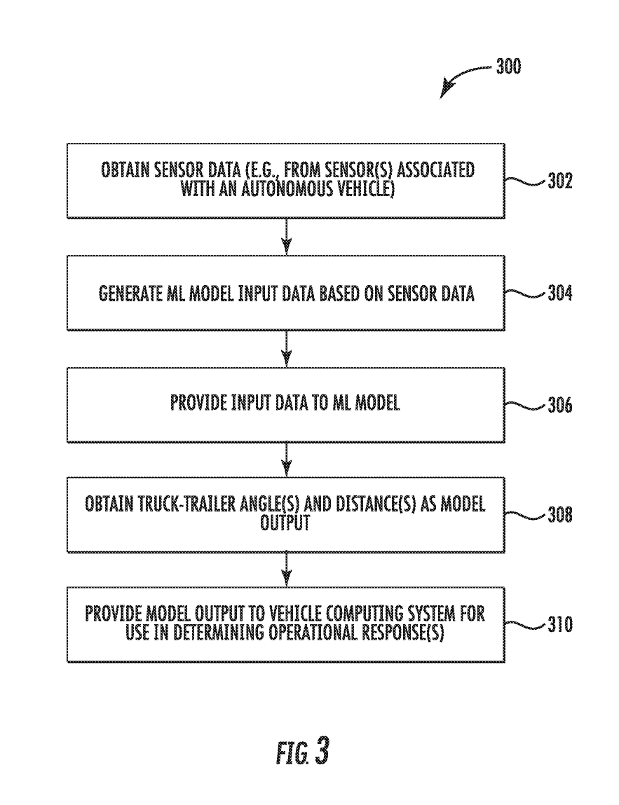

FIG. 3 depicts a flowchart diagram of example operations 300 for determining angle and/or distance data associated with an autonomous vehicle, such as an autonomous truck, according to example embodiments of the present disclosure. One or more portion(s) of the operations 300 can be implemented by one or more computing devices such as, for example, the vehicle computing system 106 of FIG. 1, the computing system 802 or 830 of FIG. 8, and/or the like. Moreover, one or more portion(s) of the operations 300 can be implemented as an algorithm on the hardware components of the device(s) described herein (e.g., as in FIGS. 1 and 8) to, for example, provide for determining one or more angles and/or one or more distances between portions of an autonomous vehicle.

At 302, one or more computing devices included within a computing system (e.g., computing system 106, 802, 830, and/or the like) can obtain sensor data from sensor(s) positioned on an autonomous vehicle. For example, sensors, such as one or more cameras, lidar sensors, and/or radar sensors, can be positioned onboard a partially or fully autonomous vehicle and can be positioned at one or more respective locations relative to the partially or fully autonomous vehicle such that a field of view of the one or more sensors includes at least some part of a first portion (e.g., a tractor portion) and/or a second portion of the vehicle (e.g., a trailer portion). The one or more sensors can be positioned on the autonomous vehicle to provide for capturing sensor data to allow for determining data regarding the vehicle (e.g., the tractor and/or the trailer).

At 304, the computing system can generate input data for a model, such as a machine-learned model, based at least in part on the sensor data. For example, in some implementations, input data can be generated based on sensor data associated with the portions of an autonomous vehicle.

At 306, the computing system can provide the input data to a trained machine-learned model. Additional example details about the machine-learned model to which input data is provided at 306 is discussed with reference to FIG. 8.

At 308, the computing system can obtain output from the machine-learned model that includes angle(s) and/or distance(s) between a first portion of the autonomous vehicle and a second portion of the autonomous vehicle (e.g., an autonomous truck having a tractor portion and a trailer portion). For example, in some implementations, the machine-learned model can output determinations of the position of the trailer and how it is moving, for example, in relation to the tractor.

At 310, the computing system can provide the model output (e.g., angle data and/or distance data), to a vehicle computing system, for use in determining one or more operations for the autonomous vehicle. In some implementations, the vehicle computing system can use the angle data and/or distance data in determining the positioning and/or movement of the first portion and the second portion of the autonomous vehicle relative to each other. The vehicle computing system can determine an appropriate vehicle response, for example, in a motion planning system and/or the like, based at least in part on the positioning of the first portion and the second portion of the autonomous vehicle relative to each other.

Although FIGS. 2 and 3 depict steps performed in a particular order for purposes of illustration and discussion, the methods of the present disclosure are not limited to the particularly illustrated order or arrangement. The various steps of the operations 200 and 300 can be omitted, rearranged, combined, and/or adapted in various ways without deviating from the scope of the present disclosure.

FIGS. 4A-4D depict block diagrams of example sensor placement configurations 400A-400D for an autonomous truck according to example embodiments of the present disclosure. FIGS. 4A-4D each illustrate a profile view and a top view of an autonomous truck.

FIG. 4A illustrates a sensor placement configuration 400A for an autonomous truck. In some implementations, such as sensor placement configuration 400A, one or more sensors, such as sensor 406, sensor 408a, and sensor 408b can be positioned on a tractor 402 of an autonomous truck, for example near the front of the tractor 402. The placement of one or more of sensor 406, sensor 408a, and sensor 408b can be configured such that the sensor(s) provide a field of view of at least part of the tractor 402 and a part of the trailer 404 for use in determining position and/or movement of the trailer 404 in relation to the tractor 402.

FIG. 4B illustrates a sensor placement configuration 400B for an autonomous truck. In some implementations, such as sensor placement configuration 400B, one or more sensors, such as sensor 410a and sensor 410b can be positioned on a tractor 402 of an autonomous truck in addition to sensor 406, sensor 408a, and sensor 408b. For example, in some implementations, the sensor 410a and sensor 410b can be positioned near the rear of tractor 402 to provide a different field of view of the trailer 404, for example, including the front and/or sides of trailer 404, for use in determining position and/or movement of the trailer 404 in relation to the tractor 402.

FIG. 4C illustrates a sensor placement configuration 400C for an autonomous truck. In some implementations, such as sensor placement configuration 400C, one or more sensors, such as sensor 412a and sensor 412b can be positioned on a tractor 402 of an autonomous truck in addition to sensor 406, sensor 408a, and sensor 408b. For example, in some implementations, the sensor 412a and sensor 412b can be positioned near the rear of trailer 404 to provide a field of view of at least part of trailer 404 and/or at least part of tractor 402 for use in determining position and/or movement of the trailer 404 in relation to the tractor 402.

FIG. 4D illustrates a sensor placement configuration 400D for an autonomous truck. In some implementations, such as sensor placement configuration 400D, one or more sensors, such as sensor 412a and sensor 412b can be positioned on a tractor 402 of an autonomous truck in addition to sensor 406, sensor 408a, sensor 408b, sensor 410a, and sensor 410b. For example, in some implementations, the sensor 412a and sensor 412b can be positioned near the rear of trailer 402 to provide a field of view of at least part of trailer 404 and/or at least part of tractor 402 for use in determining position and/or movement of the trailer 404 in relation to the tractor 402.

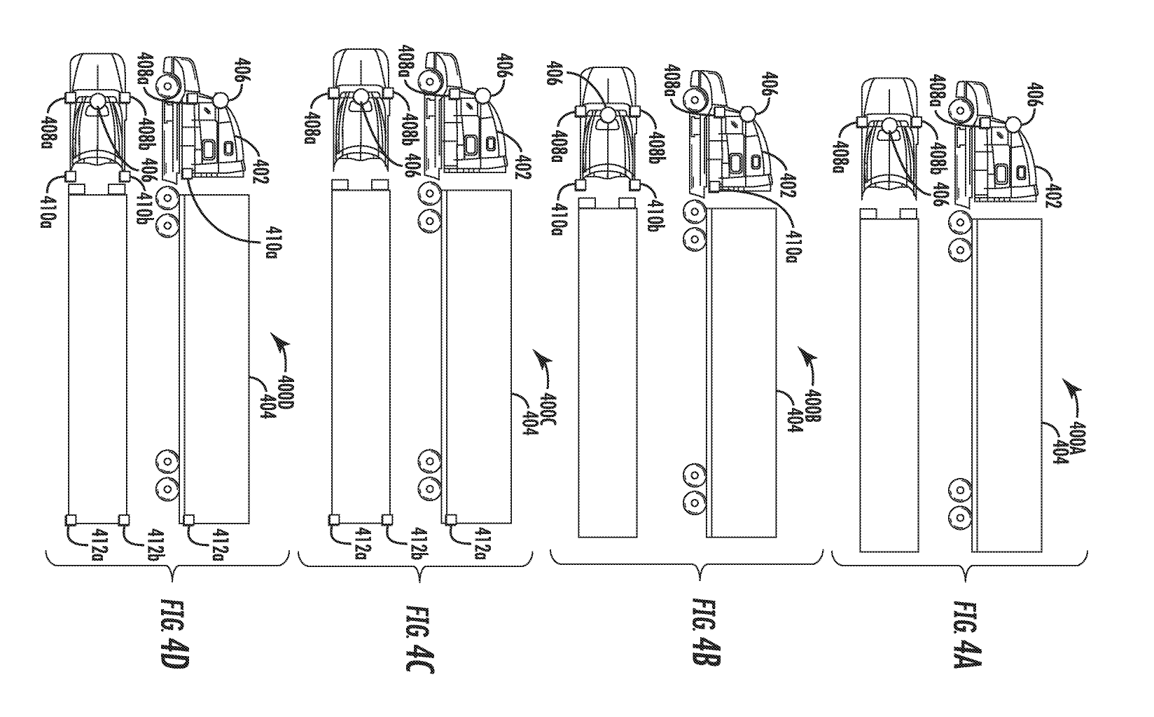

FIG. 5 depicts a block diagram of an example sensor coverage configuration 500 according to example embodiments of the present disclosure. In some implementations, one or more sensors, such as lidar sensors, radar sensors, cameras and/or the like, can be positioned on the tractor 502 and/or trailer 504 of an autonomous truck to provide fields of view relative to the autonomous truck. For example, in some implementations, one or more sensors, such as sensor 406, sensor 408a, and/or sensor 408b of FIGS. 4A-4D, can be positioned on the tractor 502 and configured to provide a field of view 506 and/or a field of view 508 ahead of the tractor 502 of the autonomous truck.

In some implementations, one or more sensors, such as sensor 408a, sensor 408a, sensor 410a, and/or sensor 410b of FIGS. 4A-4D, can be positioned on the tractor 502 and configured to provide a field of view 510 and/or a field of view 512 along the side of the tractor 502 and/or the trailer 504 of the autonomous truck.

In some implementations, one or more sensors, such as sensor 412a and/or sensor 412b of FIGS. 4C-4D, can be positioned on the trailer 504 and configured to provide a field of view 510 and/or a field of view 512 along the side of the trailer 504 and/or the tractor 502 of the autonomous truck. In some implementations, one or more sensors, such as sensor 412a and/or sensor 412b of FIG. 4, can be positioned on the trailer 504 and configured to provide a field of view 514 and/or a field of view 516 behind the trailer 504 of an autonomous truck.

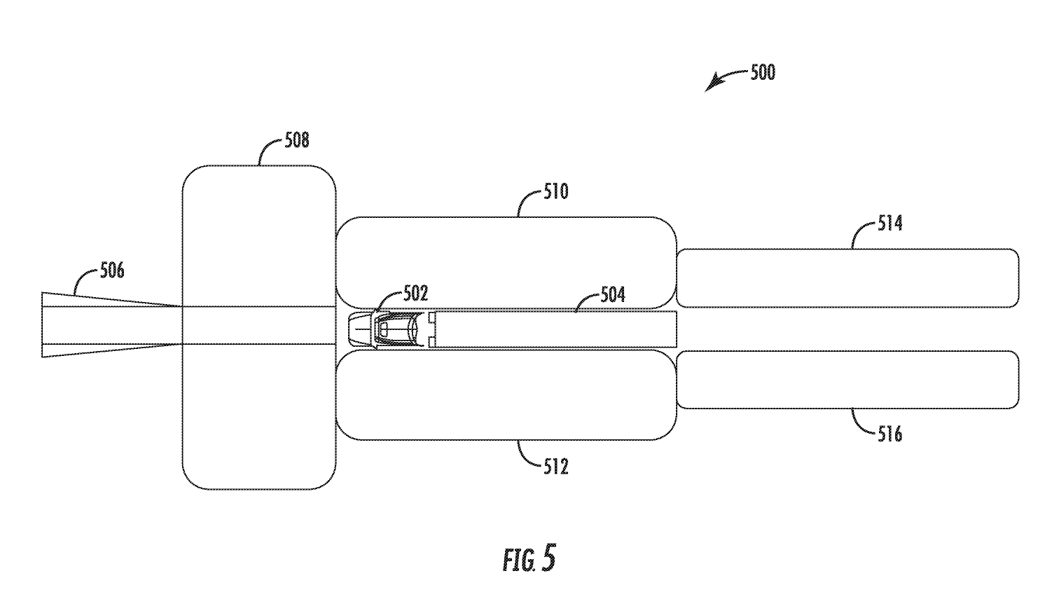

FIG. 6A depicts an example configuration 600A of first and second portions of an autonomous vehicle with sensor positioning and fields of view according to example embodiments of the present disclosure. As illustrated by configuration 600A of FIG. 6A, one or more sensors, such as sensor 606, can be positioned on a first portion 602 of an autonomous vehicle such that the sensor 606 provides a field of view 608 that includes at least a partial view of the second portion 604 of the autonomous vehicle. In some implementations, the field of view 608 of sensor 606 can also provide at least a partial view of first portion 602. In some implementations, the one or more sensors (e.g., sensor 606) can be positioned on the top of a first portion (e.g., tractor) and configured with a field of view looking back at a second portion (e.g., trailer). In some implementations, the one or more sensors (e.g., sensor 606) can be positioned on the sides of a first portion (e.g., tractor) and configured with a field of view looking back at the sides of a second portion (e.g., trailer).

FIG. 6B depicts an example configuration 600B of first and second portions of an autonomous vehicle with sensor positioning and fields of view according to example embodiments of the present disclosure. As illustrated by configuration 600B of FIG. 6B, one or more sensors, such as sensor 610, can be positioned on a second portion 604 of an autonomous vehicle, for example, near the rear of the second portion 604, such that the sensor 610 provides a field of view 612 that includes at least a partial view of the first portion 602 of the autonomous vehicle. In some implementations, the field of view 612 of sensor 610 can also provide at least a partial view of second portion 604. In some implementations, the one or more sensors (e.g., sensor 610) can be positioned on the top of a second portion (e.g., trailer) and configured with a field of view looking forward at a first portion (e.g., tractor). In some implementations, the one or more sensors (e.g., sensor 610) can be positioned on the sides of a second portion (e.g., trailer) and configured with a field of view looking forward at the sides of first portion (e.g., tractor).

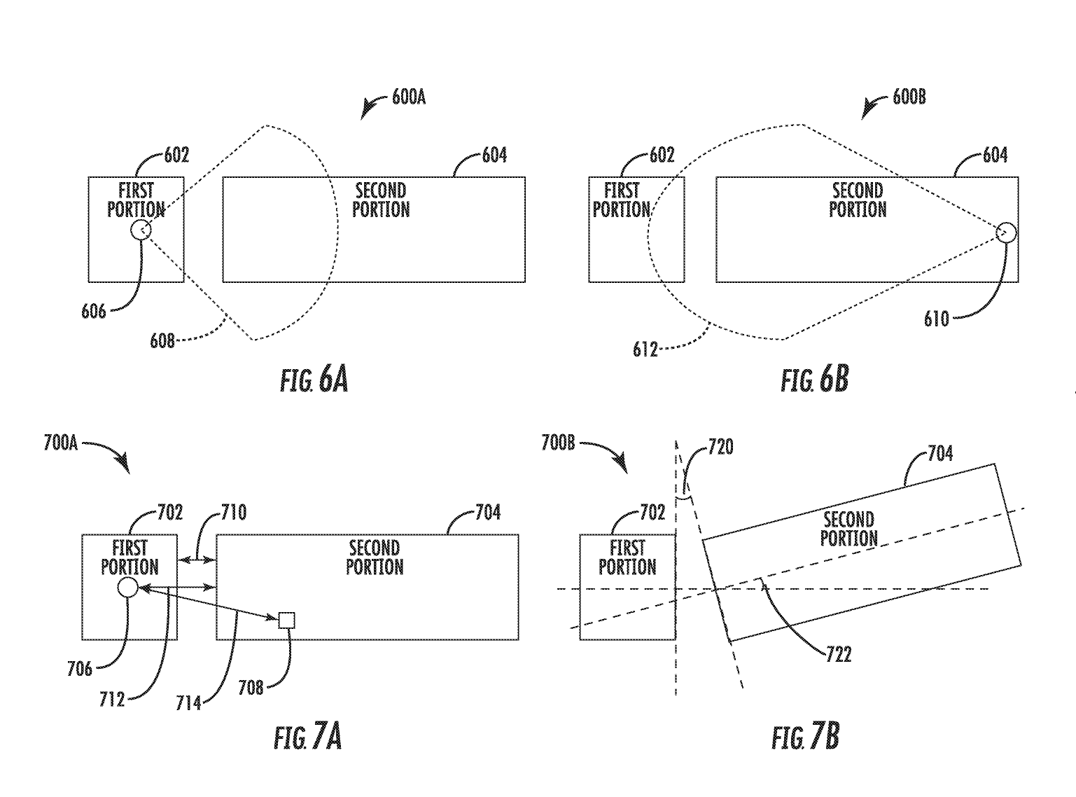

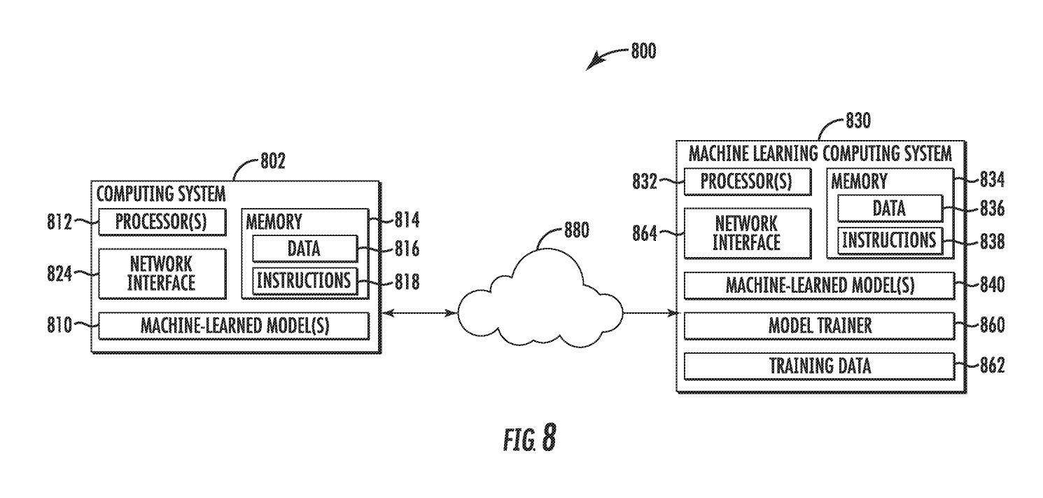

FIG. 7A depicts an example configuration 700A for determining distance(s) between a first portion 702 and a second portion 704 of an autonomous vehicle according to example embodiments of the present disclosure. As illustrated by configuration 700A of FIG. 7A, one or more sensors, such as sensor 706, can be positioned on an autonomous vehicle, for example, on a first portion 702 of the autonomous vehicle (e.g., on the top of the first portion 702, on the sides on the first portion 702, etc.). Sensor 706 can capture data associated with the autonomous vehicle for use in determining angle(s) and/or distance(s) between the first portion 702 and the second portion 704 of the autonomous vehicle. For example, in some implementations, the sensor data can provide for determining a distance 710 between the first portion 702 and the second portion 704. In some implementations, the distance 710 can be determined by detecting one or more edges of the first portion 702 and/or the second portion 704. In some implementations, the sensor data can provide for determining a distance 712 between a known location of the sensor 706 and the second portion 704, for example, by detecting a front edge and/or surface of the second portion 704.

In some implementations, the sensor 706 may be configured such that it can capture one or more defined targets, such as target 708, positioned on the second portion 704 of the autonomous vehicle. In some implementations, sensor data associated with target 708 can be used to determine a distance 714 between a known location of the sensor 706 and the target 708.

FIG. 7B depicts an example configuration 700B for determining angle(s) between a first portion 702 and a second portion 704 of an autonomous vehicle according to example embodiments of the present disclosure. As illustrated by configuration 700B of FIG. 7B, one or more angles can be determined between the first portion 702 and the second portion 704 based on senor data and can be used in determining position and/or movement of the portions of the autonomous vehicle. For example, in some implementations, an angle 720 between a rear edge and/or surface of the first portion 702 and a front edge and/or surface of the second portion 704 can be determined based on sensor data, as described herein. In some implementations, an angle 722 between a mid-line of the first portion 702 and a mid-line of the second portion 704 can be determined based on sensor data, as described herein.

FIG. 8 depicts a block diagram of an example computing system 800 according to example embodiments of the present disclosure. The example computing system 800 includes a computing system 802 and a machine learning computing system 820 that are communicatively coupled over a network 880.

In some implementations, the computing system 802 can provide for determining angle(s) and/or distance(s) between a first portion and a second portion of a partially or fully autonomous vehicle, such as, for example, a tractor portion and a trailer portion of an autonomous truck and, for example, provide for using the angle(s) and/or distance(s) in motion planning for the autonomous vehicle. In some implementations, the computing system 802 can be included in an autonomous vehicle. For example, the computing system 802 can be on-board the autonomous vehicle. In other implementations, the computing system 802 is not located on-board the autonomous vehicle. For example, the computing system 802 can operate offline to perform determination of angle(s) and/or distance(s) between portions of an autonomous vehicle. The computing system 802 can include one or more distinct physical computing devices.

The computing system 802 includes one or more processors 812 and a memory 814. The one or more processors 812 can be any suitable processing device (e.g., a processor core, a microprocessor, an ASIC, a FPGA, a controller, a microcontroller, etc.) and can be one processor or a plurality of processors that are operatively connected. The memory 814 can include one or more non-transitory computer-readable storage media, such as RAM, ROM, EEPROM, EPROM, one or more memory devices, flash memory devices, etc., and combinations thereof.

The memory 814 can store information that can be accessed by the one or more processors 812. For instance, the memory 814 (e.g., one or more non-transitory computer-readable storage mediums, memory devices) can store data 816 that can be obtained, received, accessed, written, manipulated, created, and/or stored. The data 816 can include, for instance, sensor data including image data and/or lidar data, map data, data identifying detected objects including current object states and predicted object locations and/or trajectories, autonomous vehicle state, autonomous vehicle features, motion plans, machine-learned models, rules, etc. as described herein. In some implementations, the computing system 802 can obtain data from one or more memory device(s) that are remote from the system 802.

The memory 814 can also store computer-readable instructions 818 that can be executed by the one or more processors 812. The instructions 818 can be software written in any suitable programming language or can be implemented in hardware. Additionally, or alternatively, the instructions 818 can be executed in logically and/or virtually separate threads on processor(s) 812.

For example, the memory 814 can store instructions 818 that when executed by the one or more processors 812 cause the one or more processors 812 to perform any of the operations and/or functions described herein, including, for example, determining angle(s) and/or distance(s) between a first portion and a second portion of a partially or fully autonomous vehicle, including operations described in regard to FIGS. 2 and 3.

According to an aspect of the present disclosure, the computing system 802 can store or include one or more machine-learned models 810. As examples, the machine-learned models 810 can be or can otherwise include various machine-learned models such as, for example, neural networks (e.g., deep neural networks), support vector machines, decision trees, random forest models, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

In some implementations, the computing system 802 can receive the one or more machine-learned models 810 from the machine learning computing system 830 over network 880 and can store the one or more machine-learned models 810 in the memory 814. The computing system 802 can then use or otherwise implement the one or more machine-learned models 810 (e.g., by processor(s) 812). In particular, the computing system 802 can implement the machine learned model(s) 810 to provide for determining angle(s) and/or distance(s) between a first portion and a second portion of a partially or fully autonomous vehicle.

For example, in some implementations, the computing system 802 can employ the machine-learned model(s) 810 by inputting sensor data such as image data or lidar data into the machine-learned model(s) 810 and receiving a prediction of angle(s) and/or distance(s) between a first portion and a second portion of an autonomous vehicle as an output of the machine-learned model(s) 810.

The machine learning computing system 830 includes one or more processors 832 and a memory 834. The one or more processors 832 can be any suitable processing device (e.g., a processor core, a microprocessor, an ASIC, a FPGA, a controller, a microcontroller, etc.) and can be one processor or a plurality of processors that are operatively connected. The memory 834 can include one or more non-transitory computer-readable storage media, such as RAM, ROM, EEPROM, EPROM, one or more memory devices, flash memory devices, etc., and combinations thereof.

The memory 834 can store information that can be accessed by the one or more processors 832. For instance, the memory 834 (e.g., one or more non-transitory computer-readable storage mediums, memory devices) can store data 836 that can be obtained, received, accessed, written, manipulated, created, and/or stored. The data 836 can include, for instance, sensor data including image data and/or lidar data, map data, data identifying detected objects including current object states and predicted object locations and/or trajectories, autonomous vehicle state, motion plans, autonomous vehicle features, machine-learned models, model training data, rules, etc. as described herein. In some implementations, the machine learning computing system 830 can obtain data from one or more memory device(s) that are remote from the system 830.

The memory 834 can also store computer-readable instructions 838 that can be executed by the one or more processors 832. The instructions 838 can be software written in any suitable programming language or can be implemented in hardware. Additionally, or alternatively, the instructions 838 can be executed in logically and/or virtually separate threads on processor(s) 832.

For example, the memory 834 can store instructions 838 that when executed by the one or more processors 832 cause the one or more processors 832 to perform any of the operations and/or functions described herein, including, for example, determining angle(s) and/or distance(s) between a first portion and a second portion of a partially or fully autonomous vehicle, including operations described in regard to FIGS. 2 and 3.

In some implementations, the machine learning computing system 830 includes one or more server computing devices. If the machine learning computing system 830 includes multiple server computing devices, such server computing devices can operate according to various computing architectures, including, for example, sequential computing architectures, parallel computing architectures, or some combination thereof.

In addition or alternatively to the model(s) 810 at the computing system 802, the machine learning computing system 830 can include one or more machine-learned models 840. As examples, the machine-learned models 840 can be or can otherwise include various machine-learned models such as, for example, neural networks (e.g., deep neural networks), support vector machines, decision trees, random forest models, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

As an example, the machine learning computing system 830 can communicate with the computing system 802 according to a client-server relationship. For example, the machine learning computing system 830 can implement the machine-learned models 840 to provide a service to the computing system 802. For example, the service can provide an autonomous vehicle motion planning service.

Thus, machine-learned models 810 can be located and used at the computing system 802 and/or machine-learned models 840 can be located and used at the machine learning computing system 830.

In some implementations, the machine learning computing system 830 and/or the computing system 802 can train the machine-learned models 810 and/or 840 through use of a model trainer 860. The model trainer 860 can train the machine-learned models 810 and/or 840 using one or more training or learning algorithms. One example training technique is backwards propagation of errors. In some implementations, the model trainer 860 can perform supervised training techniques using a set of labeled training data. In other implementations, the model trainer 860 can perform unsupervised training techniques using a set of unlabeled training data. The model trainer 860 can perform a number of generalization techniques to improve the generalization capability of the models being trained. Generalization techniques include weight decays, dropouts, or other techniques.

In particular, the model trainer 860 can train a machine-learned model 810 and/or 840 based on one or more sets of training data 862. The training data 862 can include, for example, image data and/or lidar data which can include labels describing positioning data (e.g., angles and/or distances) associated with an autonomous vehicle, labeled data reflecting a variety of operating conditions for an autonomous vehicle, and/or the like. The model trainer 860 can be implemented in hardware, firmware, and/or software controlling one or more processors.

The computing system 802 can also include a network interface 824 used to communicate with one or more systems or devices, including systems or devices that are remotely located from the computing system 802. The network interface 824 can include any circuits, components, software, etc. for communicating with one or more networks (e.g., 880). In some implementations, the network interface 824 can include, for example, one or more of a communications controller, receiver, transceiver, transmitter, port, conductors, software, and/or hardware for communicating data. Similarly, the machine learning computing system 830 can include a network interface 864.

The network(s) 880 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof, and can include any number of wired or wireless links. Communication over the network(s) 880 can be accomplished, for instance, via a network interface using any type of protocol, protection scheme, encoding, format, packaging, etc.

FIG. 8 illustrates one example computing system 800 that can be used to implement the present disclosure. Other computing systems can be used as well. For example, in some implementations, the computing system 802 can include the model trainer 860 and the training dataset 862. In such implementations, the machine-learned models 810 can be both trained and used locally at the computing system 802. As another example, in some implementations, the computing system 802 is not connected to other computing systems.

In addition, components illustrated and/or discussed as being included in one of the computing systems 802 or 830 can instead be included in another of the computing systems 802 or 830. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A system comprising:
one or more processors; and
memory including instructions that, when executed by the one or more processors, cause the one or more processors to perform operations, the operations comprising:
obtaining sensor data;
determining at least one angle between a first portion and a second portion of an autonomous vehicle based at least in part on the sensor data;
determining at least one distance between the first portion and the second portion of the autonomous vehicle based at least in part on the sensor data; and
providing the at least one angle and at least one distance for use in controlling operation of the autonomous vehicle.

2. The system of claim 1, further comprising one or more sensors configured to monitor aspects of the autonomous vehicle, wherein the one or more sensors are positioned on the first portion of the autonomous vehicle and configured to provide a field of view that includes at least the second portion of the autonomous vehicle, wherein the second portion is different from the first portion.

3. The system of claim 2, wherein the one or more sensors comprise one or more of a camera, a lidar sensor, or a radar sensor.

4. The system of claim 2, wherein:
the autonomous vehicle comprises an autonomous truck;
the first portion of the autonomous truck comprises a tractor of the autonomous truck and the second portion of the autonomous truck comprises a trailer of the autonomous truck; and
the one or more sensors are positioned on the tractor of the autonomous truck and configured to have a field of view that includes the trailer of the autonomous truck.

5. The system of claim 2, wherein:
the autonomous vehicle comprises an autonomous truck;
the first portion of the autonomous truck comprises a trailer of the autonomous truck and the second portion of the autonomous truck comprises a tractor of the autonomous truck; and
the one or more sensors are positioned on the trailer of the autonomous truck and configured to have a field of view that includes the tractor of the autonomous truck.

6. The system of claim 1,
wherein determining at least one angle between the first portion and the second portion of the autonomous vehicle and determining at least one distance between the first portion and the second portion of the autonomous vehicle comprises detecting one or more of:
edges of the second portion of the autonomous vehicle;
surfaces of the second portion of the autonomous vehicle; or
targets positioned on the second portion of the autonomous vehicle.

7. The system of claim 6, wherein determining at least one angle between the first portion and the second portion of the autonomous vehicle and determining at least one distance between the first portion and the second portion of the autonomous vehicle comprises evaluating one or more of the edges of the second portion of the autonomous vehicle or the targets positioned on the second portion of the autonomous vehicle to one or more of:
edges of the first portion of the autonomous vehicle detected by the one or more sensors;
surfaces of the first portion of the autonomous vehicle detected by the one or more sensors;
targets positioned on the first portion of the autonomous vehicle detected by the one or more sensors;
a known location of the one or more sensors; or
a known orientation of the one or more sensors.

8. The system of claim 1, wherein determining at least one angle between the first portion and the second portion of the autonomous vehicle and determining at least one distance between the first portion and the second portion of the autonomous vehicle comprises determining a transform between a frame of reference for the first portion of the autonomous vehicle and a frame of reference for the second portion of the autonomous vehicle.

9. The system of claim 1, wherein determining at least one angle between the first portion and the second portion of the autonomous vehicle and determining at least one distance between the first portion and the second portion of the autonomous vehicle comprises:
inputting the sensor data to a machine-learned model that has been trained to generate angle and distance estimates based at least in part on labeled training data;
obtaining an estimate of at least one angle between the first portion and the second portion of the autonomous vehicle as an output of the machine-learned model; and
obtaining an estimate of at least one distance between the first portion and the second portion of the autonomous vehicle as an output of the machine-learned model.

10. A computer-implemented method comprising:
obtaining, by a computing system comprising one or more computing devices, sensor data from one or more sensors, wherein the one or more sensors are positioned on one or more of a tractor or a trailer of an autonomous truck and configured to provide a field of view that includes the other one of the tractor and the trailer of the autonomous truck;
determining, by the computing system, one or more angles between the tractor and the trailer of the autonomous truck based at least in part on the sensor data;
determining, by the computing system, one or more distances between the tractor and the trailer of the autonomous truck based at least in part on the sensor data; and
providing, by the computing system, the one or more angles and one or more distances for use in controlling operation of the autonomous truck.

11. The computer-implemented method of claim 10, wherein the one or more sensors comprise one or more of a camera, a lidar sensor, or a radar sensor.

12. The computer-implemented method of claim 10, wherein the one or more sensors are positioned on or near a rear of the tractor of the autonomous truck and configured to provide a field of view that includes the trailer of the autonomous truck.

13. The computer-implemented method of claim 10, wherein the one or more sensors are positioned on or near the rear of the trailer of the autonomous truck and configured to provide a field of view that includes the tractor of the autonomous truck.

14. The computer-implemented method of claim 10, wherein the one or more sensors are configured to provide a field of view of the trailer of the autonomous truck; and
wherein determining one or more angles between the tractor and the trailer of the autonomous truck and determining one or more distances between the tractor and the trailer of the autonomous truck comprises detecting one or more of:
edges of the trailer of the autonomous truck; or
surfaces of the trailer of the autonomous truck; or
targets positioned on the trailer of the autonomous truck.

15. The computer-implemented method of claim 10, wherein determining one or more angles between the tractor and the trailer of the autonomous truck and determining one or more distances between the tractor and the trailer of the autonomous truck comprises determining a transform between a frame of reference for the tractor of the autonomous truck and a frame of reference for the trailer of the autonomous truck.

16. The computer-implemented method of claim 10, wherein determining one or more angles between the tractor and the trailer of the autonomous truck and determining one or more distances between the tractor and the trailer of the autonomous truck comprises:
inputting the sensor data to a machine-learned model that has been trained to generate angle and distance estimates based at least in part on labeled training data;
obtaining an estimate of one or more angles between the tractor and the trailer of the autonomous truck as an output of the machine-learned model; and
obtaining an estimate of one or more distances between the tractor and the trailer of the autonomous truck as an output of the machine-learned model.

17. An autonomous vehicle comprising:
one or more sensors positioned onboard the autonomous vehicle and configured to provide a field of view that includes the autonomous vehicle's surrounding environment as well as one or more portions of the autonomous vehicle;
a vehicle computing system comprising:
one or more processors; and
memory including instructions that, when executed by the one or more processors, cause the one or more processors to perform operations, the operations comprising:
obtaining sensor data from the one or more sensors;
detecting one or more objects that are proximate to the autonomous vehicle based at least in part on the sensor data;
determining one or more angles between a first portion and a second portion of the autonomous vehicle based at least in part on the sensor data;
determining one or more distances between the first portion and the second portion of the autonomous vehicle based at least in part on the sensor data; and
providing the one or more angles and one or more distances for use in controlling operation of the autonomous vehicle.

18. The autonomous vehicle of claim 17, wherein:
the autonomous vehicle comprises an autonomous truck;
the first portion of the autonomous truck comprises a tractor of the autonomous truck and the second portion of the autonomous truck comprises a trailer of the autonomous truck; and
the one or more sensors are positioned on the tractor of the autonomous truck and configured to have a field of view that includes the trailer of the autonomous truck.

19. The autonomous vehicle of claim 17, wherein:
the autonomous vehicle comprises an autonomous truck;
the first portion of the autonomous truck comprises a trailer of the autonomous truck and the second portion of the autonomous truck comprises a tractor of the autonomous truck; and
the one or more sensors are positioned on the trailer of the autonomous truck and configured to have a field of view that includes the tractor of the autonomous truck.

20. The autonomous vehicle of claim 17, wherein the one or more sensors are configured to provide a field of view of the second portion of the autonomous vehicle; and
wherein determining one or more angles between a first portion and a second portion of the autonomous vehicle and determining one or more distances between the first portion and the second portion of the autonomous vehicle comprises detecting one or more of:
edges of the second portion of the autonomous vehicle; or
surfaces of the second portion of the autonomous vehicle; or
targets positioned on the second portion of the autonomous vehicle.
